(19) United States
(12) Patent Application Publication
(10) Pub. No.: US 2024/0286561 A1
(43) Pub. Date: Aug. 29, 2024

(54) ACOUSTIC AND THERMAL SHIELD FOR A MOTOR VEHICLE

(71) Applicant: Treves Products, Services & Innovation, Paris (FR)

(72) Inventors: Alicia Lecomte, Paris (FR); Olivier Vitrant, Paris (FR); Marc Pothier, Paris (FR); Stéphane Ribes, Paris (FR)

(21) Appl. No.: 18/575,232

(22) PCT Filed: Jun. 28, 2022
(86) PCT No.: PCT/EP2022/067775

§ 371 Date: Dec. 28, 2023

(30) Foreign Application Priority Data
Jun. 29, 2021 (FR) 2107000

(51) Int. Cl. B60R 13/08; B29C 67/24; B29K 75/00; B29K 105/04; B29K 267/00; B29K 309/08; B29K 311/00; B32B 5/02; B32B 5/18; B32B 5/24

(52) U.S. Cl. CPC B60R 13/08; B32B 5/02; B32B 5/18; B32B 5/245; B29C 67/246; B29K 2075/00; B29K 2105/04; B29K 2267/003; B29K 2309/08; B29K 2311/00; B32B 2260/021; B32B 2260/046; B32B 2262/0253; B32B 2262/0284; B32B 2262/12; B32B 2262/16; B32B 2266/0278; B32B 2307/102; B32B 2307/304; B32B 2307/54; B32B 2605/08

(57) ABSTRACT

An acoustic and thermal shield for a motor vehicle, including a porous shell based on fibers bound together by a binding agent and a spring layer based on elastically compressible polyurethane foam, the porosity of the shell being such that the foam is able to create a sealed skin on the underside of the shell, which fibers consist of two types: thick reinforcing fibers in an amount of 25 to 40% by weight of the shell and fine fibers in an amount of 15 to 35% by weight of the shell, the bonding agent being formed by fusible bonding fibers in an amount of 35 to 50% by weight of the shell, so that substantially no foam penetrates the thickness of the shell.

The invention relates to an acoustic and thermal protective shield for a motor vehicle, to a mounting of such a shield and to a method for manufacturing such a shield.

It is known, in particular from the document FR-3 053 943, to make an acoustic and thermal protective shield for a motor vehicle, said shield comprising:
a porous shell based on thick fibers—in particular of glass-bonded together by a bonding agent—in particular based on polypropylene having undergone melting-,
a spring layer based on elastically-compressible polyurethane foam,

said shield further having the following features:
said spring layer is obtained by reaction injection molding (RIM), said layer overmolding a back face of said shell,
said shell has a porosity intended to enable said foam to create a sealed skin on the side of said face, by foam penetration into a fraction of the thickness of said shell, so that said shield is acoustically insulating, according to a “mass-spring” principle-implementing a mass layer, formed by said shell provided with said sealed skin, and said spring layer-, said shield further having acoustic absorption properties conferred by the fraction of the thickness of said shell not penetrated by said foam and remaining porous.

The aforementioned thick fibers have a large section, for example in the range of 25 microns in the case of glass fibers.

With the use of such fibers, a substantial penetration of the foam within the shell is observed, in particular in the most stretched areas of the shell, said penetration could be done across the entire thickness of said shell in the most stretched area.

This results in a reduction in the fraction of shell thickness not penetrated by said foam, and therefore a decrease in its fraction remaining porous, which is detrimental to its acoustic absorption properties.

And, consequently, an overconsumption of foam is observed leading to an increase in the cost of the shield and to an increase in its weight.

In fine, the invention aims to minimize as much as possible the penetration of the foam within the shell in order to maximize the acoustic absorption properties of the shield, and also to minimize its weight and its cost.

To this end, and according to a first aspect, the invention provides an acoustic and thermal protective shield for a motor vehicle, said shield comprising:
a porous shell based on fibers bound together by a bonding agent,
a spring layer based on elastically-compressible polyurethane foam,

said shield further having the following features:
said spring layer is obtained by reaction injection molding (RIM), said layer overmolding a back face of said shell,
said shell has a porosity intended to enable said foam to create a sealed skin on the side of said face,

knowing that:
said fibers are composed of two types of fibers:
thick reinforcing fibers in an amount from 25 to 40% by weight of said shell,
fine fibers in an amount from 15 to 35% by weight of said shell,
the bonding agent is formed by fusible bonding fibers in an amount from 35 to 50% by weight of said shell,

so that said shell is substantially free of foam penetration across its thickness.

With the suggested arrangement, the presence of fine fibers in the composition of the shell allows blocking the penetration of foam within said shell, which allows maximizing the acoustic absorption properties of the shield, and also minimizing its weight and its cost.

Furthermore, the presence of such fine fibers in the shell allows, as will be seen later on, improving its acoustic absorption properties.

According to other aspects, the invention provides a mounting of such a shield and a method for manufacturing such a shield.

Other particularities and advantages of the invention will become apparent from the following description, made with reference to the appended figures, wherein:

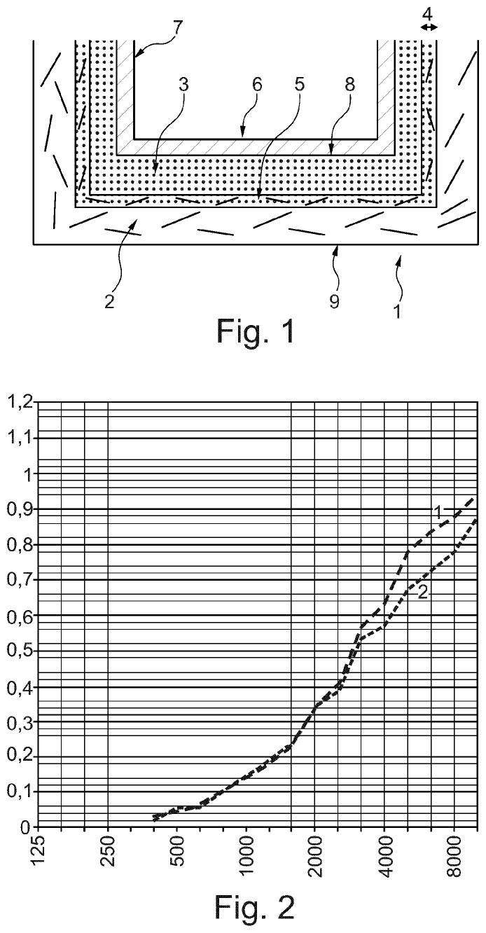

FIG. 1 is a schematic sectional view of a mounting of a shield, according to one embodiment, on a component to be protected,

FIG. 2 is a graphical illustration of the diffuse-field acoustic absorption performance (alpha coefficient in ordinate) according to the ⅓ octave frequency in Hertz of a sample derived from a shield according to the invention (curve 1), the composition of which is specified later on, and of another sample derived from a reference shield (curve 2) according to the prior art, the composition of which is also specified later on.

Referring to the figures, an acoustic and thermal protective shield 1 for a motor vehicle is described, said shield comprising:
a porous shell 2, in particular a three-dimensional shell, based on fibers bound together by a bonding agent,
a spring layer 3 based on elastically-compressible polyurethane foam,

said shield further having the following features:
said spring layer is obtained by reaction injection molding (RIM), said layer overmolding a back face of said shell,
said shell has a porosity arranged to enable said foam to create a sealed skin 5 on the side of said face,

said shield being characterized in that:
said fibers are composed of two types of fibers:
reinforcing thick fibers in an amount from 25 to 40% by weight of said shell,
fine fibers, i.e. having in particular an average diameter which is smaller than the average diameter of the thick fibers, in an amount from 15 to 35% by weight of said shell,
the bonding agent is formed by fusible bonding fibers in an amount from 35 to 50% by weight of said shell,

so that said shell is substantially free of foam penetration across its thickness.

According to one embodiment, the fraction of the thickness 4 of the shell 2 penetrated by the foam is smaller than 0.5 mm, and in particular smaller than 0.2 mm.

According to various embodiments, the reinforcing fibers are:
polyethylene terephthalate (PET) fibers with a titer between 6 and 7 dtex, said titer being in particular 6.7 dtex, corresponding to a diameter of 25 microns,
and/or glass fibers with a diameter comprised between 20 and 30 microns, said diameter being in particular 24 microns,
and/or natural fibers selected in one single type or as a mixture of different types—for example of flax, hemp or kenaf—such fibers having a variable section, in particular of 30+/−20 microns.

According to one embodiment, the fine fibers are based on polyethylene terephthalate (PET) with a titer comprised between 1.5 and 3.3 dtex, and in particular with a titer substantially equal to 1.7 dtex, corresponding to a diameter of 12 microns.

According to various embodiments, the bonding fibers are:
polypropylene fibers, in particular with a titer comprised between 6 and 7 dtex, said titer being in particular 6.7 dtex, corresponding to a diameter of 31 microns,
and/or bi-component fibers comprising a core with a high melting point and a sheath with a lower melting point, said sheath ensuring bonding between the fibers following melting thereof.

In particular, the bi-component fibers comprise a core made of polyethylene terephthalate (PET), with a melting point in the range of 250° C., and the sheath is made of polyethylene terephthalate (PET) having undergone a chemical modification so as to have a lowered melting point, for example in the range of 180° C.

The shell 2 may typically have a thickness comprised between 2 and 3 mm.

In one embodiment which is not shown, the shell 2 could be provided, over at least one of its faces, with a non-woven protective layer.

The presence of such a protective layer allows protecting the manufacturing operators from the risks of cuts by the structure fibers—in particular when they are made of glass-contained in the shell 2.

In particular, such a protective layer has a surface density comprised between 15 and 120 g/m² and in particular a resistance to the passage of air comprised between 50 and 180 N·s·m⁻³.

With such features, a protective layer directed towards the spring layer 3 does not oppose the formation of the sealed skin 5 at the back face of the shell 2.

According to one embodiment which is not shown, the front face 9 of the shell 2—i.e. that one opposite to the back face—is covered with a coating layer, for example based on a fabric.

Examples of shell 2 compositions having allowed carrying out the invention are given hereinafter.

According to a first example, the constituent fibers of the shell 2 are distributed according to the following percentages by weight:
between 15% and 25% of fine fibers based on polyethylene terephthalate (PET) and with a titer comprised between 1.5 and 3.3 dtex,
between 30% and 40% of glass fibers, in particular with a diameter comprised between 20 and 30 microns, to confer the mechanical strength,
between 40% and 50% of bonding fibers made of polypropylene ensuring bonding between the fibers of said shell following melting thereof.

According to a second example, the constituent fibers of the shell 2 are distributed according to the following percentages by weight:
between 25% and 35% of fine fibers based on polyethylene terephthalate (PET) and with a titer comprised between 1.5 and 3.3 dtex,
between 25% and 35% of mechanical strength fibers based on polyethylene terephthalate (PET) and with a titer comprised between 6 and 7 dtex,
between 35% and 45% of bonding fibers, in particular polypropylene or bi-component layers-ensuring bonding between the fibers of said shell following at least partial melting thereof.

According to a third example, the constituent fibers of the shell 2 are distributed according to the following percentages by weight:
between 15% and 25% of fine fibers based on polyethylene terephthalate (PET) and with a titer comprised between 1.5 and 3.3 dtex,
between 30% and 40% of natural fibers to confer the mechanical strength,
between 40% and 50% of bonding fibers made of polypropylene ensuring bonding between the fibers of said shell following melting thereof.

The results obtained on different samples derived from shells 2 made according to the invention are compared with a reference sample corresponding to a shell composition 2 free of fine fibers, said shell being composed of 55% of glass fibers with a diameter of 24 microns and of 45% of bonding fibers made of polypropylene with a titer of 6.7 dtex.

All tested samples have a thickness of 4 mm and a surface density of 1,000 g/m².

A substantial penetration of foam into the shell 2 is observed on the reference sample, in particular in the most stretched areas, while the samples derived from shells 2 made according to the invention are visually free of foam penetration.

The results of acoustic performances illustrated in FIG. 2 are now discussed.

The tested samples are:
a sample derived from a shell 2 according to the invention (curve 1), the composition of which is: 35% of thick fibers of glass with a diameter of 24 microns, 20% of fine fibers made of PET with a titer of 1.7 dtex and 45% of bonding fibers made of polypropylene with a titer of 6.7 dtex,
and another sample derived from a reference shell 2 (curve 2) according to the prior art, the composition of which is: 55% of thick fibers of glass with a diameter of 24 microns and 45% of bonding fibers made of polypropylene with a titer of 6.7 dtex.

Both tested samples have a thickness of 4 mm and a surface density of 1,000 g/m².

A substantial improvement in the acoustic absorption is observed with the sample derived from a shell 2 according to the invention (curve 1), in comparison with the sample derived from a shell 2 according to the prior art (curve 2), that being so for frequencies higher than about 3,000 Hz.

This improvement would be explained by the very low titer (1.7 dtex) of the fine fibers positively contributing to the acoustic absorption.

A mounting of such a shield 1 is now described, said mounting comprising said shield and a component 6 to be protected, said component being delimited by a wall 7, the visible face 8 of the spring layer 3 being shaped so as to substantially conform to the shape of said wall, so as to allow optimization of the acoustic and thermal insulation.

Finally, a method for making such a shield 1 is described comprising the following steps:
mixing:
reinforcing thick fibers in an amount from 25 to 40% by weight of the mixture,
fine fibers in an amount from 15 to 35% by weight of the mixture,
fusible bonding fibers in an amount from 35 to 50% by weight of the mixture,
making a fibrous web with said mixture,
making a porous shell 2 from a blank of said web, said blank having been heated and compressed in a cooled mold,
arranging said shell against a reaction injection mold (RIM) wall, the front face 9 of said shell being directed towards said wall,
injecting an elastically-compressible polyurethane foam precursor mixture over said shell, within the molding cavity defined by said mold,
after expansion of said foam, demolding the obtained shield 1.

What is claimed is:

1. An acoustic and thermal protective shield for a motor vehicle, said shield comprising:
a porous shell based on fibers bound together by a bonding agent,
a spring layer based on elastically-compressible polyurethane foam,
said shield further having the following features:
said spring layer is obtained by reaction injection molding (RIM), said layer overmolding a back face of said shell,
said shell having a porosity enabling said foam to create a sealed skin on the side of said face,
said fibers including two types of fibers:
thick reinforcing fibers in an amount from 25 to 40% by weight of said shell, and
fine fibers in an amount from 15 to 35% by weight of said shell,
the bonding agent formed by fusible bonding fibers in an amount from 35 to 50% by weight of said shell, so that said shell is substantially free of foam penetration across its thickness.

2. The shield according to claim 1, the fraction of the thickness of the shell penetrated by the foam being smaller than 0.5 mm.

3. The shield according to claim 1, wherein the reinforcing fibers are at least one of a group including: polyethylene terephthalate fibers with a titer comprised between 6 and 7 dtex,
glass fibers with a diameter comprised between 20 and 30 microns, and
and/or natural fibers selected in one single type or as a mixture of different types.

4. The shield according to claim 1, wherein the fine fibers are based on polyethylene terephthalate with a titer comprised between 1.5 and 3.3 dtex.

5. The shield according to claim 1, the bonding fibers being at least one of a group including:
polypropylene fibers, and
bi-component fibers comprising a core with a high melting point and a sheath with a lower melting point, said sheath ensuring bonding between the fibers following melting thereof.

6. A mounting of a shield according to claim 1, said mounting comprising said shield and a component to be protected, said component being delimited by a wall, the visible face of the spring layer being shaped so as to substantially conform to the shape of said wall, so as to allow optimization of the acoustic and thermal insulation.

7. A method for making a shield according to claim 1, comprising:
mixing:
thick reinforcing fibers in an amount from 25 to 40% by weight of the mixture,
fine fibers in an amount from 15 to 35% by weight of the mixture,
fusible bonding fibers in an amount from 35 to 50% by weight of the mixture,
making a fibrous web with said mixture,
making a porous shell from a blank of said web, said blank having been heated and compressed in a cooled mold,
arranging said shell against a reaction injection mold (RIM) wall, the front face of said shell facing said wall,
injecting an elastically-compressible polyurethane foam precursor mixture over said shell, within the molding cavity defined by said mold, and
after expansion of said foam, demolding the obtained shield.
